(19) United States
(12) Patent Application Publication
(10) Pub. No.: US 2005/0019037 A1
(43) Pub. Date: Jan. 27, 2005

(54) To can laser package with front monitoring photodetector and turning mirror

(76) Inventors: Xin Simon Luo, Monterey Park, CA (US); Matthew Swass, Tujunga, CA (US); Eva Peral, Pasadena, CA (US); Bryon Lynn Kasper, San Marino, CA (US)

Correspondence Address: CHRISTIE, PARKER & HALE, LLP, PO BOX 7068, PASADENA, CA, 91109-7068, US

(21) Appl. No.: 10/628,026

(22) Filed: Jul. 25, 2003

(51) Int. Cl. H04B 10/24

(52) U.S. Cl. 398/164

(57) ABSTRACT

A high performance transmission optical subassembly is disclosed. The transmission optical subassembly includes a laser diode transmitting an optical transmission beam from a first facet of the laser diode. A reflective mirror reflects a first portion of the optical transmission beam to an end face of an optical fiber and an edge illumination monitor photodetector, having a light receiving facet that receives a second portion of the optical transmission beam, produces a laser diode control signal as a function of the received second portion of the optical transmission beam.

### BACKGROUND

The present invention generally relates to optoelectronic telecommunications systems and more particularly relates to optoelectronic transmission subassemblies.

Optoelectronic devices such laser diodes, photodiodes and other photodetectors, have become widely used in the telecommunications and other industries. For example, optoelectronic transmitters are commonly used to convert an electrical signal into an optical signal that is propagated along a transmission medium such as an optical fiber and then converted back to an electrical signal by an optoelectronic receiver. However, the optical power of a optoelectronic transmitter can vary with changes in the operating temperature or age of the device. The temperature induced variations can result in inconsistent data transmissions.

Therefore, optical power control systems are commonly used to stabilize the optical power of signals transmitted by typical light emitters to provide more consistent data transmissions. In these systems, a portion of the light emitted from a laser diode is detected by a light-sensing device, such as a photodiode, for example, and used to generate a control signal having a signal strength proportional to the emitted optical power. The light-sensing device sends the control signal to control circuitry, which controls the optical power output of the laser diode in accordance with the signal strength of the control signal.

Many lasers, including edge emitting lasers, emit light from both the front and back facets of a lasing cavity. The front facet is generally the primary output of the laser, with substantially less light emanating from the back facet. Still, the light emanating from the back facet can provide an input to a back facet photodiode that converts the back facet light into a control signal. However, the power output from the back facet is not always directly proportional to the light which enters the fiber from the front facet, since the relative intensities of light emanating from the front and back facets can vary over time.

In addition systems that monitor the direct output of the laser often have an increased optical path length between the laser diode and the transmission medium since an intensity detector cannot be placed between the laser and the optical fiber without significantly degrading the amount of light impinging upon the fiber. However, optoelectronic transmitters typically transmit a Gaussian beam whose beamwidth increases with distance from the transmitting device. Therefore, the beamdwidth of the divergent beam incident upon the transmission medium may be significantly greater for front monitor systems as compared to rear monitor systems, thus decreasing the efficiency of transmission for front monitor systems.

### SUMMARY OF THE INVENTION

In one aspect of the present invention an optical communication device includes a laser diode transmitting an optical transmission beam, a reflective mirror that reflects a first portion of the optical transmission beam to an end face of an optical fiber and an edge illumination monitor photodetector having a light receiving facet that receives a second portion of the optical transmission beam and produces a control signal as a function of the received second portion of the optical transmission beam.

In another aspect of the present invention a method for transmitting an optical signal includes emitting the optical signal, reflecting a first portion of the optical signal to an end face of an optical fiber, receiving a second portion of the optical signal on a light receiving facet of an edge illumination monitor photodetector and generating a control signal proportional to intensity of the optical signal as a function of the received second portion of the optical signal

### BRIEF DESCRIPTION OF THE DRAWINGS

These and other features, aspects, and advantages of the present invention will become better understood with regard to the following description, appended claims, and accompanying drawings, in which:

FIG. 1 is a simplified schematic diagram of a transmitter optical subassembly having a surface illuminated front monitor photodetector;

FIG. 2 is a simplified schematic diagram of a transmitter optical subassembly having an edge illumination front monitor photodetector in accordance with an exemplary embodiment of the present invention;

FIG. 3 is a simplified schematic diagram of a transmitter optical subassembly having a surface illuminated front monitor photodetector having a swept light receiving edge facet in accordance with an exemplary embodiment of the present invention;

FIG. 4 is a simplified schematic diagram of a transmitter optical subassembly of FIG. 3 graphically illustrating refracted rays for a vertical and swept light receiving edge facet in accordance with an exemplary embodiment of the present invention; and

FIG. 5 is a view of a vertical configuration transmitter optical subassembly, which may be used to implement an exemplary embodiment in accordance with aspects of the present invention.

In accordance with common practice the various features illustrated in the drawings are not to scale. On the contrary, the dimensions of the various features are arbitrarily expanded or reduced for clarity. In addition like reference numerals denote like features throughout the specification and figures.

### DETAILED DESCRIPTION OF THE INVENTION

An exemplary embodiment of the present invention provides an apparatus and method for interfacing a high speed optoelectronic transmitter with an optical fiber. In order to appreciate the advantages of the present invention, it will be beneficial to describe the invention in the context of an exemplary optical receiver module.

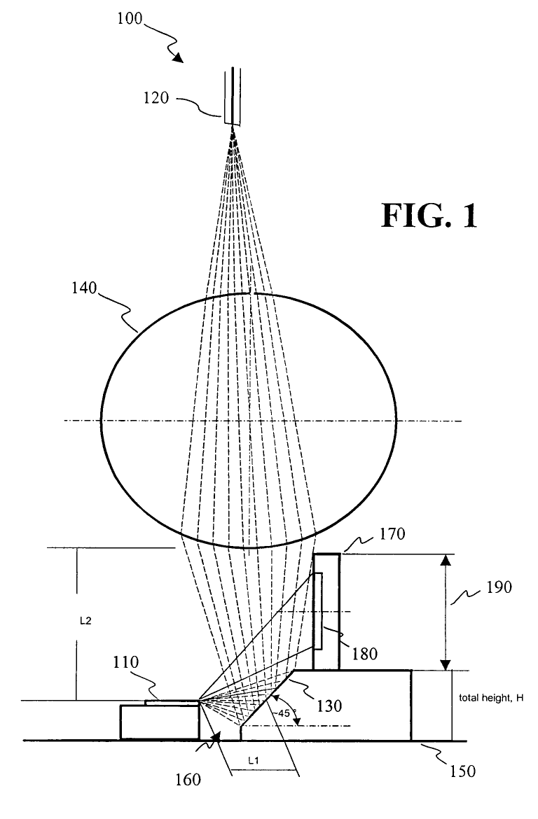

FIG. 1 illustrates a simplified schematic diagram of a conventional transmission optical sub-assembly (TOSA) 100 comprising a laser diode 110 optically coupled to an optical fiber 120 by a turning mirror 130 and a focusing lens 140. In the illustrated embodiment the laser diode 110 is coupled to at least a portion of a header 150 of a vertical TO can. The reflective turning mirror 130 folds the optical path of the transmit optical beam 160 from horizontal (i.e., generally parallel to the TO header) to vertical (i.e., generally perpendicular to the TO header). In the illustrated embodiment the mirror is swept at an angle of about 45 degrees relative to the TO header.

The focusing lens 140 is optically coupled to the turning mirror 130 and focuses the reflected beam onto an end face of the optical fiber 120. The end face of the receiving end of the optical fiber 120 is non-perpendicular to the longitudinal axis defined by the fiber core. As is known in the art the end face of the fiber may be cleaved or polished to provide a desired end face angle. In operation, optical beams reflected by the end face of the optical fiber are directed away from the mirror and therefore the laser diode thereby improving system stability and performance.

In conventional systems a monitor photodetector 170 is also integrated into a portion of the forward path of the transmit optical beam 160 emitted by the laser diode 110. The photodetector typically comprises a surface illuminated photodetector 170 with a light receiving surface substantially perpendicular to the TO header.

In operation, when the transmit optical beam is incident on the light receiving surface area 180 of the photodetector 170, electron-hole pairs are generated. A bias voltage applied across the device generates a flow of electric current having an intensity proportional to the intensity of the incident light. The output current signal of the photodetector may be coupled to an input of a control circuit (not shown) that controls the laser diode drive signal to compensate for variations in the transmit optical beam.

Typically the laser diode 110 emits a divergent optical beam having an elliptical shape. The diameter of the reflected beam incident upon the front surface of the focusing lens therefore increases with increasing distance from the laser diode. Similarly, the diameter of the focused beam incident upon the end face of the optical fiber also increases as the distance between the emitting facet of the laser diode and the front surface of the focusing lens increases.

However, for efficient optical coupling, the diameter of the core of the optical fiber is preferably equal to or greater than the diameter of the beam incident upon the end face of the fiber. Thus, the coupling efficiency between an optoelectronic transmitter and an optical fiber decreases with increasing separation distance between the emitting facet and the front surface of the focusing lens.

However, the integration of the light receiving surface of the monitor photodetector 170 in the direct optical path of the transmitted optical beam increases the optical path length between the emitting facet of the laser diode and the first surface of the focusing lens as compared to rear monitored systems. For example, the width 190 of the light receiving surface of a monitor photodetector in a front monitor system is typically in the range of about 0.3-0.5 mm to ensure consistent monitoring and feedback over the specified range of drive currents and temperatures.

Accordingly the path length between the emitting facet of the laser diode and the front surface of the focusing lens (L1+L2) in a typical front monitor system is approximately 1-3 mm longer than the path length for typical rear monitor systems. Therefore, the coupling efficiency for many conventional front monitor systems is significantly less than the coupling efficiency of comparable rear monitor systems.

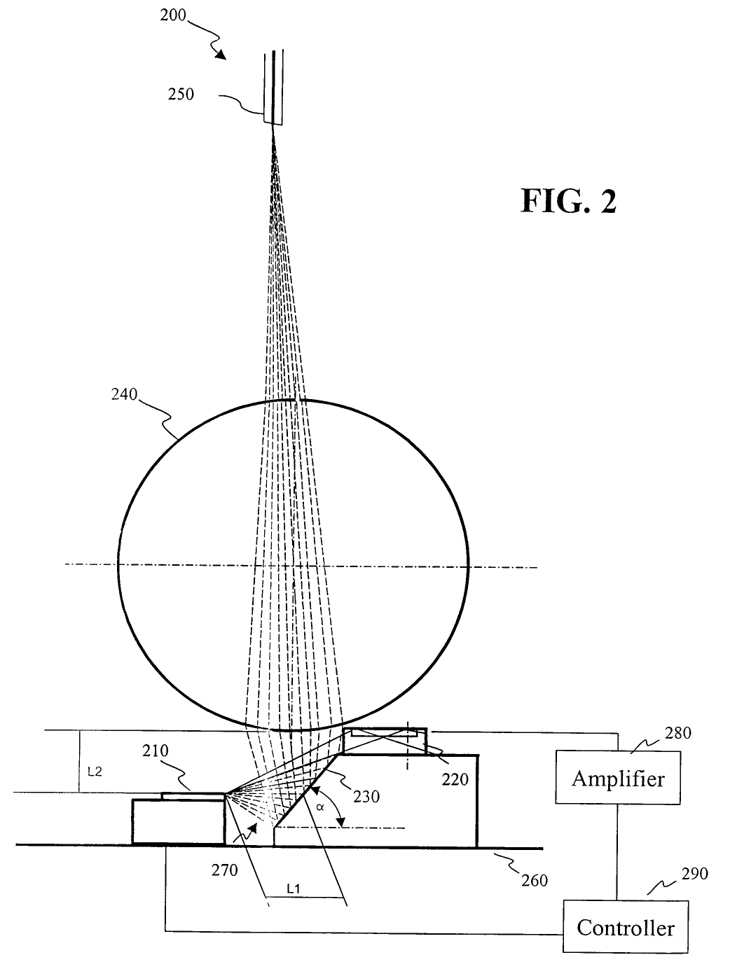

Referring to FIG. 2, an exemplary optoelectronic transmission package 200 comprises an edge illumination monitor photodetector 220 integrated into at least a portion of the forward path of the transmit optical beam 270 emitted by the laser diode 210. In the illustrated embodiment, a first portion of the transmit optical beam is incident upon a side facet of the edge illumination photodetector 220. The edge illumination photodetector 220 is coupled to a reflective turning mirror 230 that again reflects a second portion of the transmit optical beam toward a focusing lens 240 that focuses the reflected beam onto the cleaved end face of an optical fiber 250.

In operation, optical beams reflected by the end face of the optical fiber are again directed away from the mirror and therefore the laser diode, thereby improving system stability and performance. In other embodiments the front monitor optoelectronic transmission package may include an isolator between the mirror and the optical fiber so that the reflected light can be further reduced.

In the illustrated embodiment the end face of the optical fiber 250 is located at or near the back focal point of the focusing lens 240, allowing the narrowly focused beam to be efficiently captured by the optical fiber. The optical fiber 250 may be an end portion of a fiber optic cable or it may be a fiber stub enclosed at least partially in a receptacle.

The optical fiber cable or the fiber stub may be, for example, SMF-28 or any other suitable single mode or multi-mode optical fiber. In addition, one of skill in the art will appreciate that the focusing lens may comprise a symmetric lens such as the illustrated ball lens, an asymmetric lens, a graded index lens or the like.

In the illustrated embodiment the laser diode 210 again is coupled to at least a portion of a TO header 260. In one embodiment the laser diode 210 comprises a distributed feedback (DFB) laser or a Fabrey-Perot (FP) laser having an optical cavity disposed between a p-type upper cladding layer and an n-type lower cladding layer formed on an undoped substrate (not specifically shown). The optical cavity includes an active region that may comprise a single active layer, a single quantum well structure or a structure having multiple quantum wells, quantum wires or quantum dots.

In some embodiments the upper and lower cladding layers may be formed from a larger-bandgap semiconductor material than that used to form the optical cavity, creating an optical waveguide in a plane perpendicular to the junction. In an exemplary embodiment, the p-type layer may be doped with suitable dopants known in the art, such as, for example, zinc (Zn), berillium (Br) or the like and the n-type layer may be doped with a suitable n-type dopant such as, for example, silicon (Si).

In one embodiment the laser diode may comprise a semiconductor waveguide laser such as, for example, a ridge waveguide laser. In other embodiments buried hetero-structure, buried rib, or other types of lasers are used. In addition, in some embodiments, a controlled phase shift is also included in the laser or alternatively a grating may be integrated into the laser for gain/loss coupling to provide stable single mode operation.

Typically, the material composition of the laser diode is some combination of group III-V compound semiconductors, such as GaAs/AlGaAs, InGaAs/AlGaAs or InP/InGaAsP. However, other direct bandgap semiconductor materials may also be used.

In the illustrated embodiment the reflective turning mirror 230 folds the optical path of the transmit optical beam 270 from horizontal (i.e., generally parallel to the TO header) to vertical (i.e., generally perpendicular to the TO header). In the described exemplary embodiment the mirror is swept at an angle (α) in the range of about 43-47 degrees relative to the TO header.

In some embodiments the reflective mirror 230 may be coupled to the same or different semiconductor substrate as the laser diode 210. The reflective mirror 230 may be fabricated from silicon or any other suitable material.

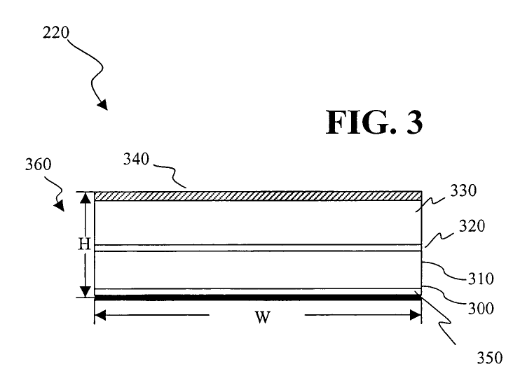

The edge illumination photodetector 220 in the illustrated embodiment may comprise an edge illuminated p-i-n photodiode. Referring to FIG. 3, in the illustrated embodiment the edge illumination photodetector 220 detects light incident upon a side facet of the photodetector. In the described exemplary embodiment, the edge illumination photodetector 220 comprises an n-type layer 310 epitaxially grown on an n-type semiconductor substrate 300. An intrinsic active layer 320 that is absorptive at the emission wavelength of the laser diode is, by way of example, epitaxially formed on the n-type layer 310. In an exemplary embodiment a p-type layer 330 is formed adjacent the intrinsic layer 320.

In an exemplary embodiment, the n-type layer 310 and p-type layer 330 may be formed of InP. The n-type layer 310 may be doped with a suitable dopant, such as, for example, sulfur and the p-type layer 330 may be doped with a suitable dopant such as Zinc. In this embodiment the intrinsic layer may be formed from InGaAs or other suitable materials known in the art.

In the illustrated embodiment the height (H) of the photodetector is typically two-five times less than the width (W) of the photodetector. Therefore, in this embodiment, the minimum path length (L1+L2) between the emitting facet of the laser diode and the front surface of the focusing lens is approximately 0.5-3 mm shorter than the path length for conventional front monitor systems that employ surface illuminated monitor photodetectors (see FIGS. 1 and 2). Therefore, the coupling efficiency for the described exemplary embodiment is significantly greater than the coupling efficiency of conventional front monitor systems.

To electrically contact the photodetector p-type and n-type ohmic contacts 340 and 350 are preferably deposited above the p-type layer 330 and below the substrate 300 respectively. The p-type ohmic contact (also referred to as an annular ohmic contact) may be formed, for example, by depositing a p-type metalization, such as gold with 2% beryllium added or a layered structure of titanium/platinum/gold above the p-type layer, defining an annular opening therein by a lithographic masking and lift-off process. The p-type ohmic contact 340 may be deposited by electron beam evaporation.

In one embodiment the n-type ohmic contact 350 may be formed, for example, by depositing an n-type metalization such as AuGe/Ni/Au on a lower surface of the substrate 300. In one embodiment, the p-type and n-type ohmic contacts 340 and 350 may be deposited over the entire upper and lower surface of the photodetector as may be desirable to provide multi-pass propagation through the active region.

In this embodiment, the transmit optical beam incident upon the light receiving facet 360 passes into the photodetector and traverses the intrinsic layer. In operation, when a reverse bias is applied across the p-type and n-type contacts, light is absorbed in the intrinsic layer and holes and electrons are separated by the electric field inducing a current proportional to the intensity of the transmit optical beam across the device.

In this embodiment, the photodetector output current is coupled to an amplifier 280 such as for example a transimpedance gain stage, that converts the current signal to a voltage signal proportional in magnitude to the optical power of the laser diode transmit optical signal (see FIG. 2). A controller 290 then compares the transimpedance voltage with a reference level and adjusts the drive current of the laser diode 210 to maintain a constant optical power output.

One of skill in the art will appreciate that the present invention is not limited to a particular photodetector. Rather the present invention may be utilized with a variety of photodetectors known in the art, such as, for example, an avalanche photodiode. Further, the photodetector may be formed from a plurality of group III-V compound semiconductors, such as, for example, GaAs/AlGaAs, InGaAs/AlGaAs or InP/InGaAsP or other direct bandgap semiconductor materials. Therefore, the disclosed exemplary p-i-n photodiode embodiment is by way of example only and not by way of limitation.

In the illustrated embodiment, the light receiving facet of the monitor photodetector 220 is approximately perpendicular to the header or parallel to the emission facet of the laser diode 210. In this embodiment, a portion of the transmit optical beam that is incident upon the light receiving facet of the monitor photodetector is refracted through the outboard edge of the photodetector without being absorbed by the active layer.

Therefore, the edge illumination photodetector may have to be relatively wide to ensure that the transmit optical beam is efficiently detected by the edge illumination photodetector 220. However, making the photodetector “artificially” larger to ensure efficient absorption of the incident light reduces the bandwidth of the device while increasing the device costs.

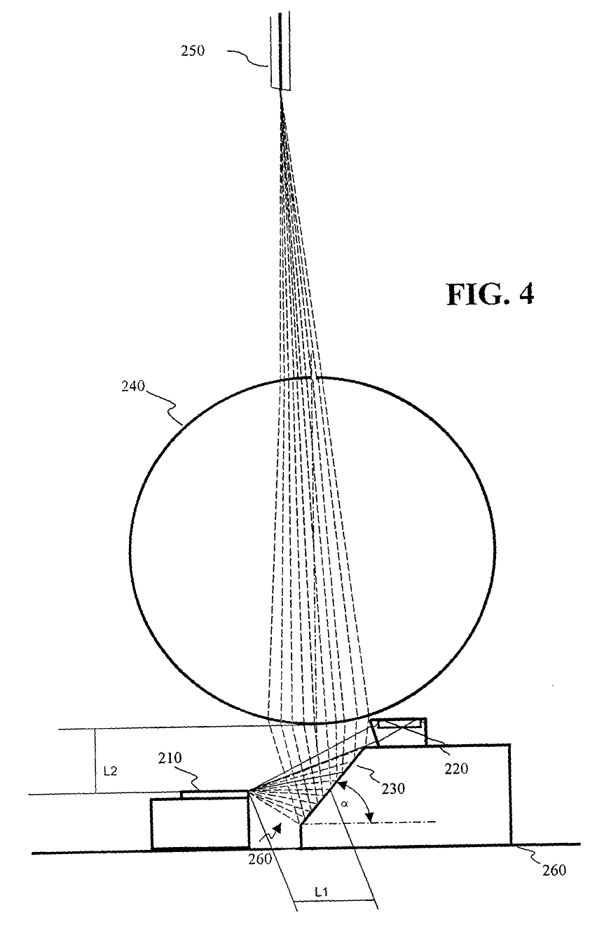

Therefore, in some embodiments the light receiving facet of the edge illumination photodetector 220 is swept to more efficiently refract the incident beam into the active region of the photodetector as illustrated in the schematic diagram of FIG. 4. In one embodiment the light receiving facet may be swept at an angle (β) in the range of about 43-47 degrees from the flat TO Header. However, one of skill in the art will appreciate that the sweep angle of the light receiving facet of the photodetector may vary as a function of the material composition of the photodetector, the far field transmit angles of the laser diode or the like. Therefore the disclosed sweep angle is by way of illustration only and not by way of limitation.

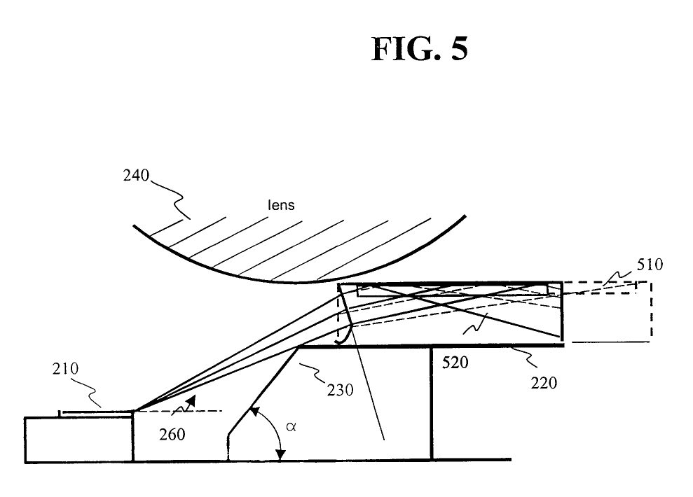

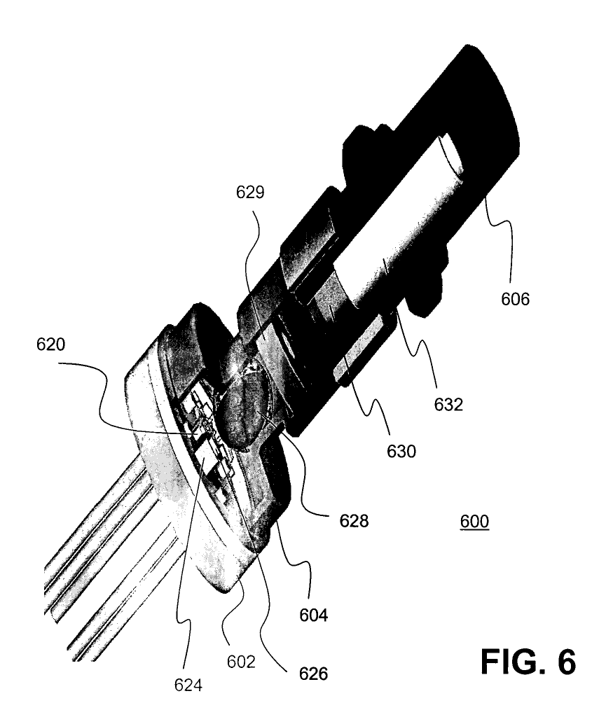

Simple ray tracing techniques may be used to optimize the sweep angle of the light receiving facet as a function of the separation between the emitting facet of the laser diode, the far field angle of the laser diode and the material composition of the photodetector. For example, FIG. 5 graphically illustrates the beams 510 (shown as dashed lines) refracted by a vertical light receiving facet as well as the beams 520 refracted by a light receiving facet swept 47 degrees from the horizontal TO header. In this embodiment the swept light receiving facet more efficiently couples the incident light beam into the active layer of the photodetector while the vertical light receiving facet refracts portions of the light beam out the outboard facet of the device.

The described exemplary TOSA 600, as illustrated in FIG. 6, is a vertical configuration TOSA that includes a TO header 602 with an opto-electronic assembly. In this embodiment a reflective mirror 624 is coupled to the TO. In one embodiment the reflective mirror is formed, by way of example, from silicon, and is swept 47 degrees relative to the TO header. The TO header 602 also has mounted thereon a laser diode 620 on a substrate. The laser diode 620 may be a DFB laser, a Fabry-Perot laser or any other suitable edge emitting or other laser.

In the illustrated embodiment an edge illumination monitoring photodiode 626 is coupled to the top of the reflective mirror 624. The TO header 602 is coupled to a lens holder 604 that holds a ball lens 628. The TOSA 600 also includes a fiber stub 630 and a fiber sleeve 632 that at least partially envelopes the fiber stub. The fiber sleeve 632 is held inside a receptacle 606, which may be of any suitable type, such as LC, SC, MU, FC or the like.

In the illustrated embodiment a laser diode isolator 629 is integrated between the ball lens 628 and the fiber stub 630 to rotate the polarized beam (e.g., DFB laser output) by 45 degrees. The reflecting polarized beam from the fiber stub surface is rotated again by 45 degrees by the LD isolator 629 so that the reflected light can be further reduced, and the isolation may be greater than approximately 25 to 30 dB. In the exemplary embodiment, the LD isolator 629 includes a 0-degree polarizer, garnet material and a 45-degree polarizer. In other embodiments, LD isolators may include other components.

It will be appreciated by those of ordinary skill in the art that the invention can be embodied in other specific forms without departing from the spirit or essential character thereof. For example, in one embodiment the laser diode, turning mirror and front monitor photodetector may be monolithically formed on a common substrate. In this embodiment an inclined plane is etched into the common substrate at the desired turning angle by chemical means or by ionic machining using reactive or non-reactive ion beams. In one embodiment the substrate comprises, by way of example, indium phosphide, InP. In this embodiment a laser diode may then be formed laterally adjacent to the turning mirror. A edge illuminated front monitor photodetector may then be epitaxially formed on an upper surface of the turning mirror.

The present invention is therefore considered in all respects to be illustrative and not restrictive. The scope of the invention is indicated by the appended claims, and all changes that come within the meaning and range of equivalents thereof are intended to be embraced therein. For example, the optical interface in other embodiments may include two or more lenses. Further, the optical interface may also include two or more fold mirrors in the optical path to direct the optical beam to a desired location.

1. An optical communication device, comprising:
a laser diode emitting an optical transmission beam;
a reflective mirror that reflects a first portion of the optical transmission beam to an end face of an optical fiber; and
an edge illumination monitor photodetector, having a light receiving facet that receives a second portion of the optical transmission beam, the monitor photodetector producing a control signal as a function of the received second portion of the optical transmission beam.

2. The optical communication device of claim 1 further comprising a focusing lens optically coupled to the reflective mirror for focusing the reflected optical beam into the end face of the optical fiber.

3. The optical communication device of claim 1, wherein the laser diode comprises an edge emitting laser.

4. The optical communication device of claim 1, wherein the laser diode and the reflective mirror are coupled to a TO header, and wherein the reflective mirror is swept at an angle to reflect the first portion of the optical transmission beam to the optical fiber.

5. The optical communication device of claim 4 wherein the reflective mirror is swept an angle in the range of about 43-47 degrees relative to the TO header.

6. The optical communication device of claim 5 wherein the light receiving facet of the edge illumination monitor photodetector is swept at an angle relative to the TO header.

7. The optical communication device of claim 1 further comprising a gain stage coupled to the edge illumination monitor photodetector that converts the control signal to a voltage proportional to the intensity of the optical transmission beam and a control that compares the voltage to a reference voltage and adjusts drive current of the laser diode in accordance with the comparison.

8. The optical communication device of claim 2, further comprising a laser diode isolator disposed between the focusing lens and the optical fiber.

9. The optical communication system of claim 1 wherein the monitor photodetector comprises a p-i-n photodetector.

10. The optical communication system of claim 1 wherein the monitor photodetector is coupled to the reflective mirror.

11. The optical communication system of claim 1 wherein the reflective mirror comprises a silicon reflective mirror.

12. A method for transmitting an optical signal, comprising:
emitting the optical signal;
reflecting a first portion of the optical signal to an end face of an optical fiber;
receiving a second portion of the optical signal on a light receiving facet of an edge illumination monitor photodetector; and
generating a control signal proportional to intensity of the optical signal as a function of the received second portion of the optical signal.

13. The method of claim 12 further comprising converting control signal to a voltage that is proportional to intensity of the optical signal and adjusting intensity of the optical signal in accordance with the voltage.

14. The method of claim 12 further comprising focusing the reflected optical signal into the end face of the optical fiber.

15. An optical communication device, comprising:
a laser diode emitting an optical transmission beam from a first facet of the laser diode;
a reflective mirror that reflects a first portion of the optical transmission beam emitted from the first facet of the laser diode to an end face of an optical fiber; and
an edge illumination monitor photodetector, having a light receiving facet that receives a second portion of the optical transmission beam emitted from the first facet of the laser diode, wherein the monitor photodetector produces a control signal as a function of the received second portion of the optical transmission beam.

16. The optical communication device of claim 15 further comprising a focusing lens optically coupled to the reflective mirror for focusing the reflected optical beam into the end face of the optical fiber.

17. The optical communication device of claim 15, wherein the laser diode comprises an edge emitting laser.

18. The optical communication device of claim 15, wherein the laser diode and the reflective mirror are coupled to a TO header, and wherein the reflective mirror is swept at an angle to reflect the first portion of the optical transmission beam to the optical fiber.

19. The optical communication device of claim 18 wherein the reflective mirror is swept an angle in the range of about 43-47 degrees relative to the TO header.

20. The optical communication device of claim 18 wherein the light receiving facet of the edge illumination monitor photodetector is swept at an angle relative to the TO header.

21. The optical communication device of claim 15 further comprising a gain stage coupled to the edge illumination monitor photodetector that converts the control signal to a voltage proportional to the intensity of the optical transmission beam and a control that compares the voltage to a reference voltage and adjusts drive current of the laser diode in accordance with the comparison.

22. The optical communication device of claim 16, further comprising a laser diode isolator disposed between the focusing lens and the optical fiber.

23. The optical communication system of claim 15 wherein the monitor photodetector comprises a p-i-n photodetector.

24. The optical communication system of claim 15 wherein the reflective mirror comprises a silicon reflective mirror.
